(19) United States
(12) Patent Application Publication
(10) Pub. No.: US 2007/0014535 A1
(43) Pub. Date: Jan. 18, 2007

(54) System and method for renting or purchasing digital media

(75) Inventors: Darryl T. Rathbun, Stratford, CT (US); Theresa Biasi, Shelton, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/181,569

(22) Filed: Jul. 14, 2005

(51) Int. Cl. H04N 5/91

(52) U.S. Cl. 386/94

(57) ABSTRACT

A system for providing a selected digital medium to a customer on request. The selected digital medium has a selected title recorded thereon. The system includes a data storage device that stores a digital copy of available titles, a digital recording device, a blank digital media storage unit for storing blank digital media, a digital media inventory storage unit, and a digital media dispenser. The digital media inventory storage unit stores for available titles a predetermined number of digital media having a particular title recorded thereon. After the selected digital medium is requested by the customer, the digital recording device receives a digital copy of the selected title or another title and records the selected title or other title onto one of the blank digital media, which is then stored in the digital media inventory storage unit.

### FIELD OF THE INVENTION

The present invention relates to vending systems, and in particular to a system and method for renting or purchasing digital media such as CDs or DVDs.

### BACKGROUND OF THE INVENTION

Traditionally, when individuals wanted to purchase and/or rent a compact disk (CD) containing digital music and/or digital video content such as a movie (DVD), the individual would have to visit a retail location such as a music/entertainment store or a video rental store to complete their transaction. Retail stores are sometimes not convenient because they are in limited geographic locations and typically have limited operating hours. Alternatively, individuals can also complete a CD/DVD purchase or rental transaction online using one of many known web sites devoted to such a purpose. While more convenient in some ways, online solutions typically require added time and cost for shipping the CD/DVD to the individual.

More recently, vending systems, such as kiosks or other vending type machines, have become available which allow an individual to purchase and/or rent a CD or DVD therefrom, possibly at a more convenient location than a particular retail store or at times when retail stores are not open. Such vending systems are typically of one of two types. The first type is a vending system that stocks an inventory of ready CDs and/or DVDs having particular titles and dispenses such CDs and DVDs on request (after payment therefor is made). Examples of such systems are described in U.S. Pat. No. 5,523,551 to Scott and U.S. Pat. No. 5,445,295 to Brown. The problem with such systems is that when the inventory of a particular title is exhausted, the vending system is not be able to dispense that title until the physical inventory of that title is replenished. In the second type of system, an inventory of blank media (e.g., CDs and DVDs) is maintained and CDs and DVDs having particular titles are created (“burned”) from stored (locally or remotely) digital information and dispensed to individuals on demand. Examples of such systems are described in U.S. Pat. No. 5,633,839 to Alexander et al. and U.S. Pat. No. 6,655,580 to Ergo et al. The problem with this second type of system is that the process of creating the CDs and DVDs takes time, which is often enough of an inconvenience to lose customers.

### SUMMARY OF THE INVENTION

The present invention relates to a system for providing a selected digital medium, such as a CD or DVD, to a customer on request. The selected digital medium has a selected title recorded thereon that is one of a plurality of available titles. The system includes a data storage device that stores a digital copy of available titles, a digital recording device, such as a CD/DVD writer, a blank digital media storage unit for storing blank digital media, a digital media inventory storage unit, and a digital media dispenser for dispensing the selected digital medium to the customer. The digital media inventory storage unit stores a predetermined number of digital media having available titles recorded thereon that can be dispensed to a customer upon request. In the system, after the selected digital medium is requested and/or dispensed to the customer, the digital recording device receives a digital copy of the selected title, or another title if the selected title is not going to be replaced in inventory, and records the selected or another title onto one of the blank digital media to create a recorded medium. The recorded medium is then stored in the digital media inventory storage unit to replace the digital medium dispensed to the customer.

The data storage device may be located locally with respect to the digital recording device, the blank digital media storage unit, the digital media inventory storage unit, and the digital media dispenser, or, alternatively, it may be located remotely therefrom. Where the data storage device is located locally, the system may also include a remote data storage device, wherein the local data storage device receives the digital copy of one or more of the available titles from the remote data storage device. The predetermined number for each particular one of said available titles may be the same, such as one or two, or may differ among the titles.

The present invention also relates to a method of providing a selected digital medium to a customer, wherein the selected digital medium has a selected title recorded thereon, the selected title being one of a plurality of available titles. The method includes receiving a request for the selected digital medium and obtaining the selected digital medium from a digital media inventory, wherein the inventory stores for each particular one of the available titles a predetermined number of digital media having the particular one of the available titles recorded thereon. The method further includes providing the selected digital medium to the customer, obtaining a blank digital medium, recording the selected title, or another title, onto the blank digital medium to create a recorded medium, and storing the recorded medium in the inventory so that is can be subsequently dispensed upon request. The selected digital medium, digital media, blank digital medium, and recorded medium may comprise CDs, DVDs, or another form of recordable media. Providing the selected digital medium to the customer may follow the storing the recorded digital media in the inventory, or may precede obtaining a blank digital medium and recording the selected title or another title onto the blank digital medium.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a vending system for renting or purchasing CDs, DVDs or similar digital media according to an embodiment of the present invention;

FIG. 2 is a flowchart illustrating a method of renting or purchasing CDs, DVDs or similar digital media according to an embodiment of the present invention;

FIG. 3 is a flowchart illustrating a method of replacing inventory when a digital medium is dispensed according to an embodiment of the present invention; and

FIG. 4 is a flowchart illustrating a method of changing the inventory stored in the vending system according to an embodiment of the present invention.

### DESCRIPTION OF THE PREFERRED EMBODIMENTS

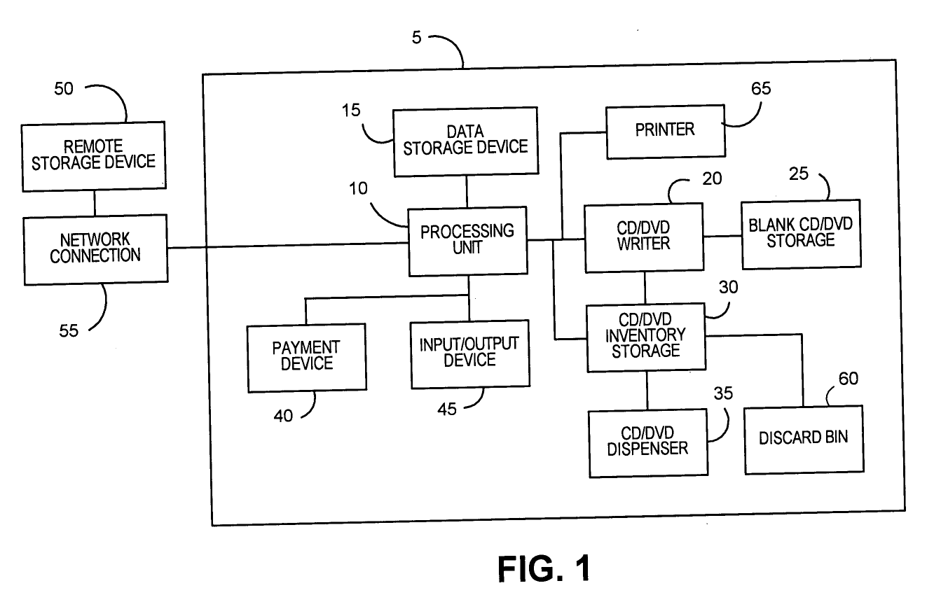

FIG. 1 is a block diagram of a vending system 5 for vending CDs, DVDs or similar digital media according to the present invention. Vending system 5 overcomes the above-described drawbacks of prior art vending systems by maintaining an inventory of a predetermined number of each CD or DVD title available for immediate dispensing and replacing each CD or DVD in the inventory as it is purchased and/or rented with a CD or DVD of the same or different title. Vending system 5 is preferably housed in a kiosk or similar structure that is readily accessible to individuals desiring to acquire CDs and DVDs.

Vending system 5 includes a processing unit 10, such as, without limitation, a microprocessor. Data storage device 15, such as, without limitation, a hard drive or the like, is in electronic communication with processing unit 10. Data storage device 15 stores a digital copy of each CD and/or DVD title (i.e., particular audio or audiovisual content) that is available from vending system 5. Vending system 5 also includes a CD/DVD writer 20 that is in electronic communication with the processing unit 10. The CD/DVD writer 20 is a digital recording device that, as is known in the art, is able to record digital information onto a CD or DVD (also known as “burning”). In the present invention, the CD/DVD writer 20 is adapted to selectively record one of the CD or DVD titles that are stored in data storage device 15 onto a blank CD or DVD. It should be noted that while FIG. 1 illustrates a single CD/DVD writer 20, more than one writer 20 may be provided if desired.

Vending system 5 also includes a blank CD/DVD storage unit 25 that is adapted to store a supply of blank, writable CDs and/or DVDs. Blank CD/DVD storage unit 25 also includes or is operatively coupled to a transport mechanism that, on command, transports one of the blank CDs and/or DVDs to the CD/DVD writer 20 so that digital information can be recorded thereon. Vending system 5 can also optionally include a printer 65 that can be used to print an image on the CD/DVD or its protective sleeve to identify which title is recorded onto each CD/DVD. A CD/DVD inventory storage unit 30 is also provided for storing CDs and DVDs that have had digital information recorded thereon by the CD/DVD writer 20 (i.e., that have been “burned” by the CD/DVD writer 20). In particular, for each title that is available for immediate dispensing from vending system 5, CD/DVD inventory storage unit 30 stores a predetermined number of CDs and/or DVDs having that title recorded thereon. The predetermined number may be the same for each title, such as one or two, or may differ among the titles depending upon the anticipated demand therefor. CD/DVD inventory storage unit 30 includes or is operatively coupled to a first transport mechanism that, on command, transports each CD and/or DVD recorded by the CD/DVD writer 20 to CD/DVD inventory storage unit 30 for storage therein. CD/DVD inventory storage unit 30 also includes or is operatively coupled to a second transport mechanism that, on command, transports one of the CDs or DVDs stored by CD/DVD inventory storage unit 30 to CD/DVD dispenser 35, which in turn dispenses the transported CD or DVD to the customer.

It should be noted that the data storage device 15 can store the same or a different number of titles than are stored in the inventory storage unit 30. For example, it may be desirous to store a large number of titles in the data storage device 15, including older movies which may not be requested by customers very often, and thus do not warrant keeping a recorded medium in the inventory storage unit 30. By maintaining such copies in the data storage device 15, a customer could still select a less common title that is not currently available in the CD/DVD inventory storage 30 to be burned onto a digital medium. Conversely, it may desirous to remove a title from the data storage device 15 although a recorded medium of the title still exists in the inventory storage unit 30. Thus, the data storage device 15 may store a first plurality of available titles, while the CD/DVD inventory storage 30 may include a second plurality of available titles that is the same as or different than the first plurality of available titles stored in the data storage device 15.

CD/DVD inventory storage unit 30 can also include or be operatively coupled to a third transport mechanism that, on command, transports one of the CDs or DVDs stored by CD/DVD inventory storage unit 30 that is no longer needed for inventory to discard bin 60 for later disposition as described below. The first, second, and third transport mechanisms may be independent mechanisms or may be performed by fewer mechanisms in any combination.

A payment device 40 and an input/output device 45 are each in electronic communication with processing unit 10. Payment device 40 is adapted to accept cash or read credit cards, debit cards or other payment instruments for purposes of obtaining payment information for the desired transaction (e.g., the purchase of a DVD). The payment information is then transmitted to processing unit 10 for processing thereby in a known manner. Input/output device 45, such as a keyboard, display, touch screen or the like, enables a customer to provide transaction requests, such as a selection of a desired title, to processing unit 10, and allows the processing unit to communicate instructions to the customer.

Vending system 5 may also be in electronic communication with a remote storage device 50, such as a database coupled to a server, through network connection 55. Remote storage device 50 stores digital copies of numerous CD and/or DVD titles. Selected titles can thus be downloaded to vending system 5 through network connection 55 for storage in data storage device 15 so that those titles can be made available to customers. When a new title is added to data storage device 15 in this manner and the new title is to be added to the inventory of titles available for immediate dispensing, the CD/DVD writer 20 can record that title onto one or more blank CDs or DVDs (depending on the predetermined number that are to be stored for that title) from blank CD/DVD storage 25 and stores the recorded CDs or DVDs in CD/DVD inventory storage unit 30. Alternatively, data storage device 15 could be eliminated, in which case the digital copy of each title will be stored in remote storage device 50 and downloaded from the remote storage device 50 to vending system 5 as needed.

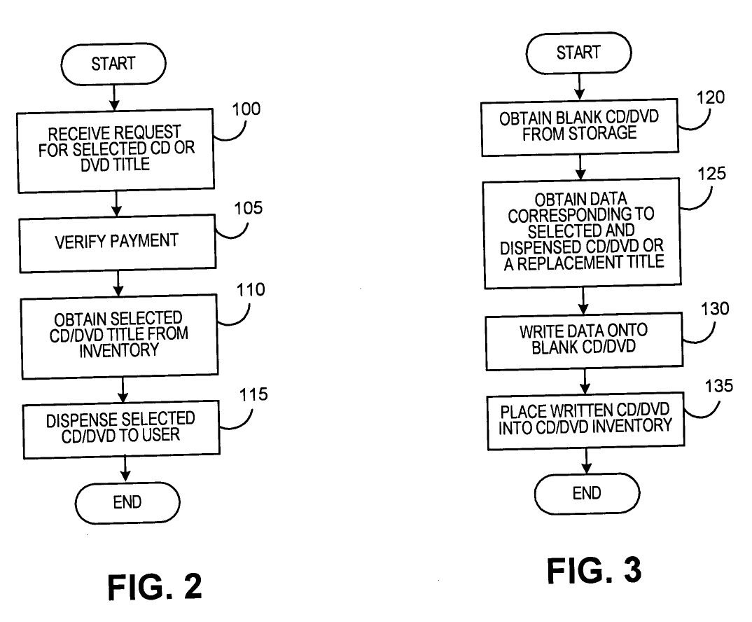

FIG. 2 is a flowchart illustrating a preferred method of providing CDs, DVDs or similar digital media to customers according to an embodiment of the present invention. The method begins at step 100 where processing unit 10 receives a request from a customer to purchase or rent a selected CD or DVD title that is available (stored in CD/DVD inventory storage 30) or, in the case where the selected title was just dispensed and no more recorded copies are available in the CD/DVD inventory storage 30, will soon be available (currently being recorded by the CD/DVD writer 20). At step 105, payment for the purchase or rental is verified by processing unit 10. Specifically, payment device 40 accepts and verifies cash or reads data from the customer's credit card, debit card, or some other payment means, and transfers it to processing unit 10 where it is verified using known means. If payment is insufficient, the customer can be asked to try a different payment method or add additional cash until the payment is sufficient. If the payment remains insufficient after some predetermined number of tries, the transaction can be cancelled. Next, at steps 110 and 115, a CD or DVD having the selected title recorded thereon is obtained from CD/DVD inventory storage unit 30 and dispensed to the customer through CD/DVD dispenser 35. If the title is currently being recorded by the CD/DVD writer 20, the vending system 5 will wait until the recorded title is available before proceeding to step 110.

FIG. 3 illustrates a method of replacing inventory when a digital medium is dispensed (as described with respect to FIG. 2) according to an embodiment of the present invention. The processing in FIG. 3 can start while the processing as described in FIG. 2 is being performed e.g., after payment has been verified in step 105, or after the selected CD/DD title has been obtained from inventory in step 110, or can wait until after the CD/DVD has been dispensed to the customer in step 115. In step 120, a blank CD or DVD, as appropriate, is obtained from blank CD/DVD storage unit 25 and transported to the CD/DVD writer 20. At step 125, the data for the title selected and dispensed at steps 100, 110 and 115 is obtained from data storage device 15 and provided to the CD/DVD writer 20. Alternatively, if it is desired not to replace the title that was just selected and dispensed, data for a replacement title could be substituted for the selected title. Thus, the inventory stored in the CD/DVD inventory storage 30 can be updated to remove older titles and make room for new releases. Then, at step 130, the data obtained in step 125 is recorded onto (i.e., written or burned onto) the blank CD or DVD obtained in step 120 by the CD/DVD writer 20. Finally, at step 135, the CD or DVD having the data recorded thereon in step 130 is transported to CD/DVD inventory storage unit 30 where it is stored for subsequent dispensing to a customer on request.

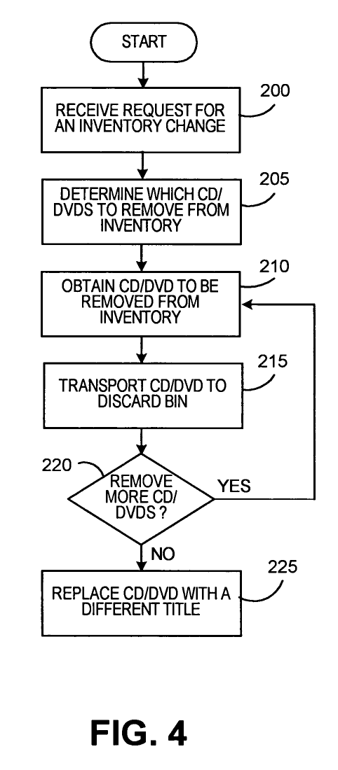

Optionally, instead of waiting for all of the inventory of a selected title to be exhausted before replacing the selected title with a replacement title, the predetermined number of each available CD or DVD title can also be changed by removing old titles to be replaced by either new titles or more CDs or DVDs with an existing title in order to meet future purchase demand. FIG. 4 is a flowchart that shows how a CD/DVD can be discarded from inventory so it can be replaced by a CD/DVD of a different title. The method begins at step 200 where the processing unit 10 receives a request for an inventory change from a software program that predicts future buying trends or to add the latest release. At step 205, a software program determines one or more of CD/DVDs to remove from inventory based on past request trends and future request predictions. Alternatively, steps 200 and 205 could be made either locally or remotely by either a person or a software program that predicts future requests. Then, during steps 210 through 220, each CD/DVD to be removed from inventory is obtained from CD/DVD inventory storage unit 30 and deposited into discard bin 60. Finally, at step 225, the plurality of CDs or DVDs discarded from CD/DVD inventory storage unit 30 are replaced in a manner similar to steps 120 through 135 in FIG. 3.

Thus, the system and method of the present invention represent an improvement over prior art vending systems. In particular, the system and method of the present invention overcome the disadvantages of the prior art, namely the problem of exhausted inventory in the prior art systems that don't burn CDs or DVDs on demand and the time delay and inconvenience problems of prior art systems that burn each requested CD or DVD on demand, by maintaining an inventory of a predetermined number of each available CD or DVD title and replacing each CD or DVD in the inventory as it is purchased and/or rented with a CD or DVD of the same title.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A system for providing a selected digital medium to a customer on request, said selected digital medium having a selected title recorded thereon, said selected title being one of a first plurality of available titles, comprising:
a data storage device storing a digital copy of each of a second plurality of available titles;
a digital recording device;
a blank digital media storage unit for storing blank digital media;
a digital media inventory storage unit, said digital media inventory storage unit storing for each particular one of said first plurality of available titles a respective predetermined number of digital media having one of said first plurality of available titles recorded thereon; and
a digital media dispenser for dispensing said selected digital medium having said selected title recorded thereon to said customer;
wherein after said selected digital medium is requested by said customer, a digital copy of one of said second plurality of available titles is recorded by said digital recording device onto one of said blank digital media to create a recorded medium, and said recorded medium is stored in said digital media inventory storage unit.

2. The system according to claim 1, wherein said digital copy of one of said second plurality of available titles that is recorded by said digital recording device onto one of said blank digital media is said selected title dispensed to said customer.

3. The system according to claim 1, wherein said digital copy of one of said second plurality of available titles that is recorded by said digital recording device onto one of said blank digital media is different than said selected title dispensed to said customer.

4. The system according to claim 1, wherein said data storage device is located locally with respect to said digital recording device, said blank digital media storage unit, said digital media inventory storage unit, and said digital media dispenser.

5. The system according to claim 1, wherein said data storage device is located remotely from said digital recording device, said blank digital media storage unit, said digital media inventory storage unit, and said digital media dispenser.

6. The system according to claim 1, wherein said selected digital medium, said digital media and said blank digital media comprise CDs.

7. The system according to claim 1, wherein said selected digital medium, said digital media and said blank digital media comprise DVDs.

8. The system according to claim 1, wherein the respective predetermined number for each particular one of said first plurality of available titles is the same.

9. The system according to claim 1, wherein the respective predetermined number for at least some of said first plurality of available titles is different.

10. The system according to claim 1, wherein said first plurality of available titles and said second plurality of available titles are identical.

11. A method for a kiosk to provide a selected digital medium to a customer, said selected digital medium having a selected title recorded thereon, comprising:
receiving a request from said customer for said selected digital medium having said selected title recorded thereon;
in response to receiving said request, obtaining said selected digital medium having said selected title recorded thereon from a digital media inventory stored in said kiosk, said inventory storing for a first plurality of available titles a respective predetermined number of digital media having one of said first plurality of available titles recorded thereon;
providing said selected digital medium having said selected title recorded thereon to said customer;
obtaining a blank digital medium from a plurality of blank digital media stored in said kiosk;
recording, using a recording device in said kiosk, one of a second plurality of available titles onto said blank digital medium to create a recorded medium; and
storing said recorded medium in said inventory in said kiosk.

12. The method according to claim 11, wherein recording further comprises:
recording said selected title onto said blank digital medium to create a recorded medium.

13. The method according to claim 11, wherein said selected digital medium, said digital media and said blank digital medium comprise CDs.

14. The method according to claim 11, wherein said selected digital medium, said digital media and said blank digital medium comprise DVDs.

15. The method according to claim 11, wherein the respective predetermined number of digital media having one of said first plurality of available titles recorded thereon is the same for each of said first plurality of available titles.

16. The method according to claim 11, wherein the respective predetermined number of digital media having one of said first plurality of available titles recorded thereon is different for at least some of said first plurality of available titles.

17. The method according to claim 11, further comprising receiving a stored digital copy of said selected title, wherein said recording step utilizes said stored digital copy of said selected title.

18. The method according to claim 11, wherein the respective predetermined number of digital media having one of said first plurality of available titles recorded thereon can be changed.

19. The method according to claim 11, wherein said first plurality of available titles and said second plurality of available titles are identical.
